(19) United States
(12) Patent Application Publication
(10) Pub. No.: US 2014/0328507 A1
(43) Pub. Date: Nov. 6, 2014

(54) INCREASING ANTENNA PERFORMANCE FOR WIRELESS HEARING ASSISTANCE DEVICES

(71) Applicants: Jay Rabel, Shorewood, MN (US); Jorge F. Sanguino, Hopkins, MN (US)

(72) Inventors: Jay Rabel, Shorewood, MN (US); Jorge F. Sanguino, Hopkins, MN (US)

(21) Appl. No.: 14/272,185

(22) Filed: May 7, 2014

Related U.S. Application Data
(63) Continuation-in-part of application No. 14/267,708, filed on May 1, 2014.
(60) Provisional application No. 61/818,371, filed on May 1, 2013.

(51) Int. Cl. H04R 25/00

(52) U.S. Cl. CPC H04R 25/554; H04R 25/60
USPC 381/315

(57) ABSTRACT

Disclosed herein, among other things, are methods and apparatus for increasing antenna performance for hearing assistance devices. One aspect of the present subject matter includes a receiver-in-canal (RIC) hearing assistance device for a wearer including an antenna within a device housing, an audio receiver configured to be worn in an ear canal of a wearer, and a cable assembly configured to connect the audio receiver to the device housing. A circuit component, such as a ferrite bead or an inductor, is connected to the cable assembly and configured to adjust coupling between the cable assembly and the antenna by modifying high frequency current through the wires of the cable assembly. According to various embodiments, the circuit component is configured to enhance radiation from the cable assembly conductors to assist in wireless communications. In other embodiments, the circuit component is configured to limit and make more consistent the radiation from the cable assembly conductors that interfere with antenna transmissions.

### CLAIM OF PRIORITY AND INCORPORATION BY REFERENCE

The present application is a continuation-in-part of and claims the benefit of priority under 35 U.S.C. §120 to U.S. patent application Ser. No. 14/267,708, filed on 1 May 2014, which application claims the benefit under 35 U.S.C. §119(e) of U.S. Provisional Patent Application 61/818,371, filed 1 May 2013, the disclosure of which are hereby incorporated by reference herein in their entirety.

### TECHNICAL FIELD

This document relates generally to hearing assistance systems and more particularly to methods and apparatus for increasing antenna performance for wireless hearing assistance devices.

### BACKGROUND

Modern hearing assistance devices, such as hearing aids, are electronic instruments worn in or around the ear that compensate for hearing losses by specially amplifying sound. Some hearing aids include an antenna for radio frequency (RF) communications. Antenna performance can be affected by coupling of the antenna system with conductors of an audio receiver, which creates a flow of high frequency current through the audio receiver wires, causing the wires to become an RF radiator. This coupling between the antenna and the audio receiver cables can cause a variance in RF gain which can create wireless link performance problems.

Accordingly, there is a need in the art for improved systems and methods for increasing antenna performance for hearing assistance devices.

### SUMMARY

Disclosed herein, among other things, are methods and apparatus for increasing antenna performance for hearing assistance devices. One aspect of the present subject matter includes a receiver-in-canal (RIC) hearing assistance device for a wearer including an antenna within a device housing, an audio receiver configured to be worn in an ear canal of a wearer, and a cable assembly configured to connect the audio receiver to the device housing. A circuit component, such as a ferrite element (such as a bead) or an inductor, is connected to the cable assembly and configured to adjust coupling between the cable assembly and the antenna by modifying high frequency current through the wires of the cable assembly. According to various embodiments, the circuit component is configured to enhance radiation from the cable assembly conductors to assist in wireless communications. In other embodiments, the circuit component is configured to limit and make more consistent the radiation from the cable assembly conductors that interfere with antenna transmissions.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 illustrates a schematic diagram of a receiver-in-the-canal (RIC) hearing assistance device.

FIG. 2 illustrates a schematic diagram of a receiver-in-the-canal (RIC) hearing assistance device with a circuit component adjacent the device housing, according to various embodiments of the present subject matter.

FIG. 3 illustrates a schematic diagram of a receiver-in-the-canal (RIC) hearing assistance device with a circuit component adjacent the receiver assembly, according to various embodiments of the present subject matter.

FIG. 4 illustrates a schematic diagram of a receiver-in-the-canal (RIC) hearing assistance device with a circuit component within the device housing, according to various embodiments of the present subject matter.

FIG. 5 illustrates a schematic diagram of a receiver-in-the-canal (RIC) hearing assistance device with an adjustably located circuit component, according to various embodiments of the present subject matter.

FIG. 6 illustrates a schematic diagram of a receiver-in-the-canal (RIC) hearing assistance device with multiple circuit components, according to various embodiments of the present subject matter.

FIG. 7 illustrates a cross-sectional view of a receiver-in-the-canal (RIC) hearing assistance device, according to various embodiments of the present subject matter.

FIG. 8 illustrates a portion of a receiver cable for connecting to a device housing, according to various embodiments of the present subject matter.

FIG. 9 illustrates a portion of a receiver cable for connecting to a receiver assembly, according to various embodiments of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present detailed description will discuss hearing assistance devices using the example of hearing aids. Hearing aids are only one type of hearing assistance device. Other hearing assistance devices include, but are not limited to, those in this document. It is understood that their use in the description is intended to demonstrate the present subject matter, but not in a limited or exclusive or exhaustive sense.

Some hearing aids include an antenna for radio frequency (RF) communications. Antenna performance can be affected by coupling of the antenna system with conductors of an audio receiver, which creates a flow of high frequency current through the audio receiver wires, causing the wires to become an RF radiator and causing transmission to be much different than reception for the antenna. For certain wire lengths (based on cable assembly length) and impedances (based on receiver type), the wires will become the primary radiator with higher radiation efficiency than the intended hearing aid antenna. The variance in RF gain can create wireless link performance problems. If the antenna gain is increased, the hearing aid RF receiver will be exposed to higher levels of undesirable signals that will degrade its sensitivity performance in some environments (examples: near a cell phone hub, tower or repeater). The hearing aid RF transmit power variation may be too high to meet regulatory requirements.

Disclosed herein, among other things, are methods and apparatus for increasing antenna performance for hearing assistance devices. One aspect of the present subject matter includes a receiver-in-canal (RIC) hearing assistance device for a wearer including an antenna within a device housing, an audio receiver configured to be worn in an ear canal of a wearer, and a cable assembly configured to connect the audio receiver to the device housing. A circuit component, such as a ferrite element, an inductor, a capacitor, or other component, is connected to the cable assembly and configured to adjust coupling between the cable assembly and the antenna by modifying high frequency current through the wires of the cable assembly. According to various embodiments, the circuit component is configured to enhance radiation from the cable assembly conductors to assist in wireless communications. In other embodiments, the circuit component is configured to limit and make more consistent the radiation from the cable assembly conductors that interfere with antenna transmissions.

The present subject matter improves wireless RIC hearing aids antenna performance. In addition, the present subject matter improves antenna system gain consistency with different length cables and different types of receivers, and when worn by different users. Thus, the present subject matter can be used to manage transmit and receive performance of the antenna system. One prior solution to this problem was to use ferrites on the flex substrate that are located inside the antenna aperture. However, locating ferrites inside the antenna aperture provides less control of the induced current. This yields poorer improvement of gain consistency and less gain control. The present subject matter locates the ferrites or inductors outside the antenna aperture.

The present subject matter uses the audio wireless receiver, connecting cables, inductors and ferrites to adjust induced RF current flow on the receiver/cable assemblies to control hearing aid antenna system gain and make antenna performance more consistent (less uncontrolled) with different length cables and/different types of receivers. This will also improve consistency when worn by different hearing aid wearers. Thus, the present subject matter employs the use and control of induced RF current flow on the receiver/cable assemblies to control hearing aid antenna system gain.

During hearing aid operation, current is induced on RIC cable/receiver assemblies that affects the wireless HA antenna system gain and gain sensitivity to different length cables, different types of receivers, and human tissue proximity. In various embodiments, the present subject matter provides series ferrites or inductors that are inserted in the receiver cable lines to reduce, control or enhance induced RF current flow on the receiver/cable assemblies to control hearing aid system gain and make antenna performance more consistent (less un-controlled) across users. When the device housing is directly coupled to the receiver cables, greater gain variation due to receiver/cable to tissue proximity, tissue density, etc. will be seen. In one embodiment, to increase control or minimize RF current flow on the cable assembly, the ferrite or inductor is located outside of the antenna aperture. The use of inductors or properly selected ferrites reduces hearing aid system antenna gain and gain sensitivity to different length cables and different types of receivers.

In various embodiments, the present subject matter can control the current distribution along the cable-receiver assembly to optimize antenna system gain consistency. Various embodiments include modifying conductor impedance through modifications of geometry, materials, number of conductors and their coupling. In various embodiments, distributed coupling components are added to better match the output impedance of the receiver and transmitter ports of the radio. Various embodiments can control induced RF current flow (current distribution) on the receiver/cable assemblies to control (adjust) hearing aid antenna system gain and to control (adjust) antenna system performance sensitivity to different length receiver cables, different receiver types and sizes, and different users (head size, shape and tissue density variations). Various embodiments use ferrites, inductors and other distributed matching components for this function, and use varying conductive materials and geometries of those conductors to control the impedance of the receiver cable to make it a more effective radiator for RF communication.

During hearing aid operation, RF current can be coupled to RIC cable/receiver assemblies. This affects the wireless HA antenna system gain and gain sensitivity to different length cables, different types of receivers (acoustic transducers), and human tissue proximity. RF current is electromagnetically coupled to the cable assemblies due to the placement and orientation of the audio traces and cables relative to one or more radiating traces and antenna elements that are internal to the hearing aid. The present systems and methods shown to control cable-receiver RF current distribution and antenna system gain apply whether the RF current is electromagnetically coupled or directly connected from the RF radio circuit to the cable-receiver assembly.

Different cable lengths (to fit different users) and different receiver types (to meet their hearing loss needs) result in different RF electrical lengths and impedances, different current distributions, and have different radiation efficiencies. Consequently, the antenna system gain and impedance can vary significantly for each combination of cable and receiver used. When worn by a hearing aid user, portions of the radiating/receiving receiver-cable assembly are in close proximity to human tissue which can cause additional changes to the impedance, radiation efficiency and pattern directivity. Differences between individual users such as head and outer-pinna size-and-shape and tissue density further contribute to antenna system gain variations. If tightly coupled to the receiver cables, greater gain variation due to receiver-cable to tissue proximity, tissue density, etc. will be seen.

According to various embodiments, RF current flow (current distribution) can be controlled by selecting one-or-more component insertion location(s) (placement), and by selection of one-or-more component RF impedance value(s). In various embodiments, a component value is selected to present desired RF impedance to current flow. Higher impedances will reduce current flow through component more than lower impedances. Various embodiments can adjust location for desired electrical length (example: quarter wave). Additional embodiments can adjust location for desired balance between radiation efficiency and sensitivity to head tissue gap and density variations.

To control or adjust the RF current flow on the cable assembly, one location for the ferrite or inductor would be outside of the antenna aperture. In one example, inserting an impedance (circuit element) in a cable-receiver assembly in a location a small distance from the head/tissue of the wearer to reduce current flow that would be in very close proximity to human tissue to reduce the tissue loading effects. Further embodiments adjust the distance from head/tissue loading to maximize antenna system gain for the desired range of users. In another example, if multiple receiver cable lengths are required, one or more impedances could be inserted in a location(s) that create the same (or similar) electrical lengths in the different cable assemblies at the desired operating frequencies. In various embodiments, conductor geometry and the number of conductors can be adjusted to improve induced current on the cable. Distributed matching elements can be added to the cable assemblies to improve matching for the purpose of making the conductor a more effective radiator for RF communication, in various embodiments. By adjusting the conductors, their lengths, diameter, and geometries, the receiver cables can be designed to be consistent and useful radiators for RF communication, in various embodiments. Conductors can be shielded over some of their length to improve their matching and consistency as effective radiators, in an embodiment. Matching components can be distributed over their length to improve their matching and consistency as effective radiators.

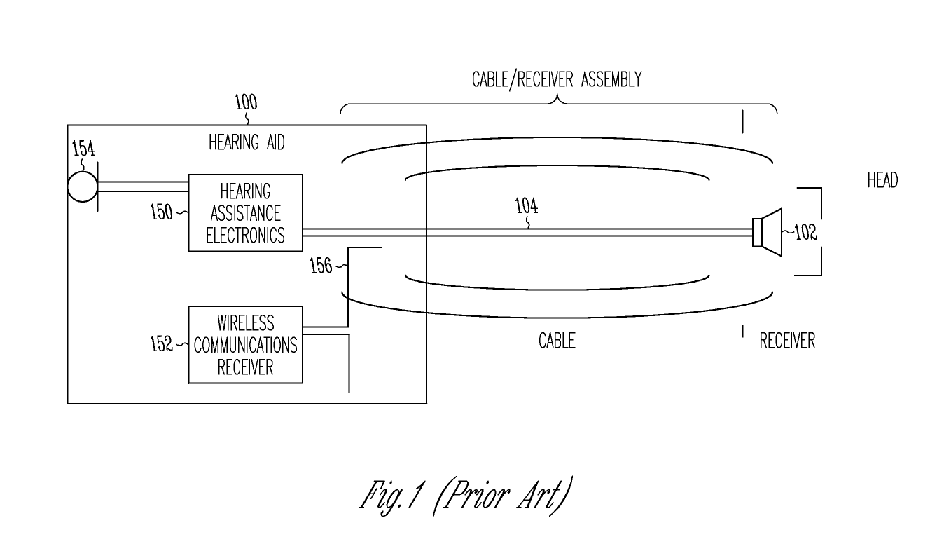

FIG. 1 illustrates a schematic diagram of a receiver-in-the-canal (RIC) hearing assistance device. The device includes a housing 100 including a microphone 154 connected to hearing assistance electronics 150, and a wireless communications module 152 connected to an antenna 156. A cable assembly 104 connects the hearing assistance electronics 150 to the receiver 102 to be worn in an ear of a wearer. RF current is electromagnetically coupled to the cable assembly 104 due to placement and orientation of the audio traces and cables relative to one or more radiating traces and antenna elements 156 that are internal to the hearing assistance device.

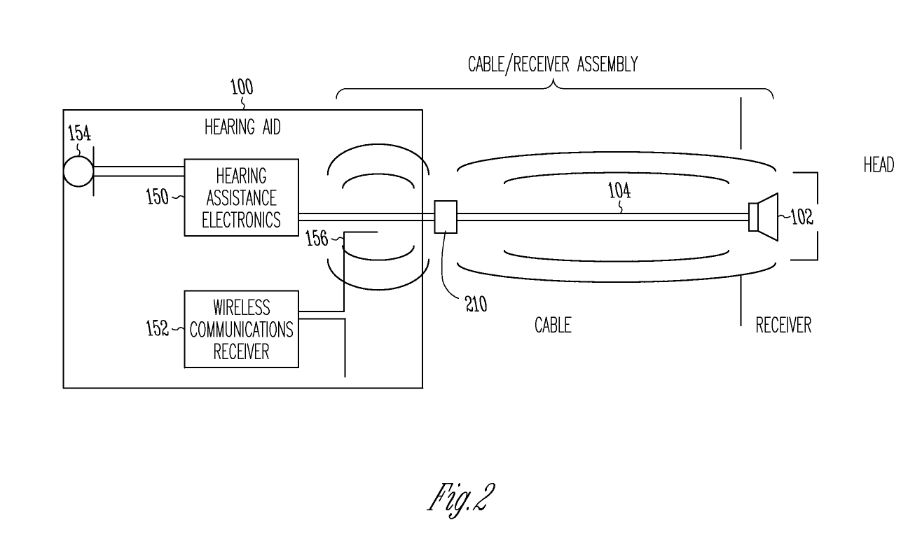

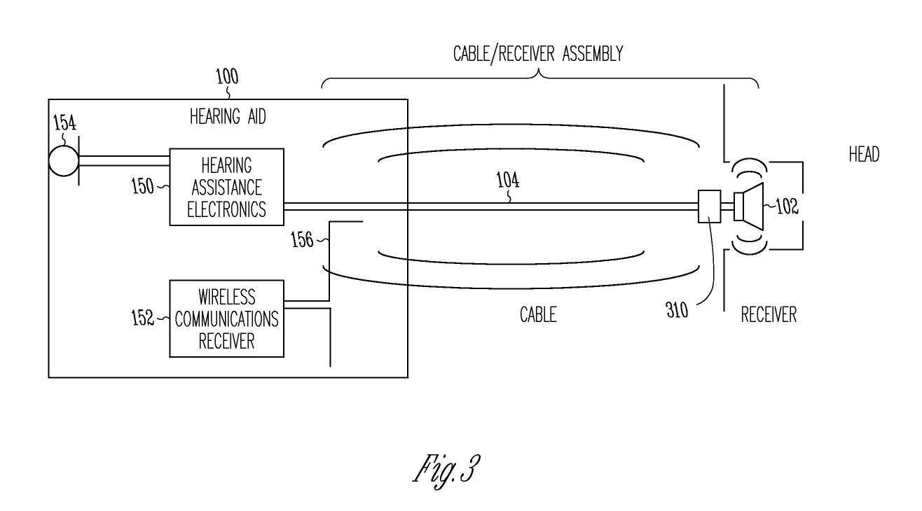

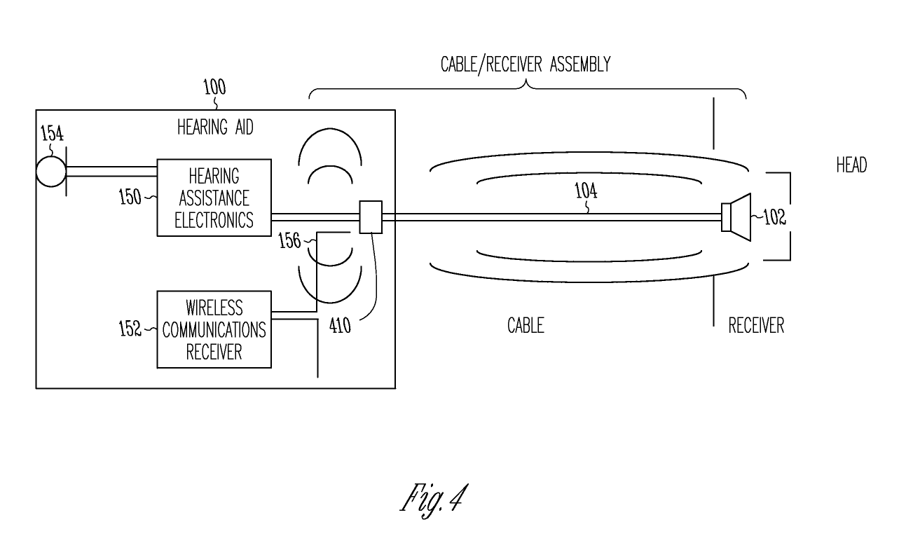

FIG. 2 illustrates a schematic diagram of a receiver-in-the-canal (RIC) hearing assistance device with a circuit component adjacent the device housing, according to various embodiments of the present subject matter. The depicted embodiment includes a series circuit component 210 in a cable near a connection to the hearing assistance device. FIG. 3 illustrates a schematic diagram of a receiver-in-the-canal (RIC) hearing assistance device with a circuit component adjacent the receiver assembly, according to various embodiments of the present subject matter. The depicted embodiment includes a series circuit component 310 in a cable near a connection to the receiver 102 or receiver assembly housing the receiver. FIG. 4 illustrates a schematic diagram of a receiver-in-the-canal (RIC) hearing assistance device with a circuit component within the device housing, according to various embodiments of the present subject matter. The depicted embodiment includes a series circuit component 410 inside the hearing assistance device housing.

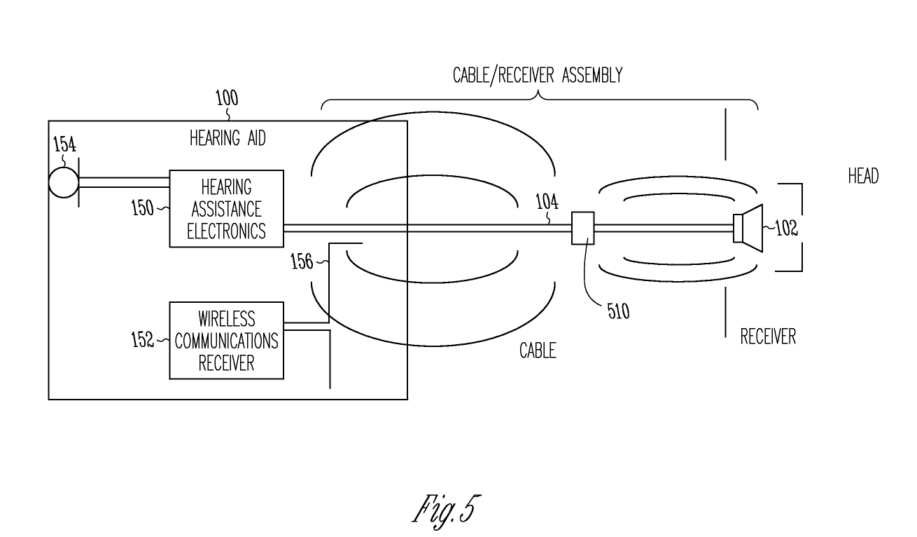

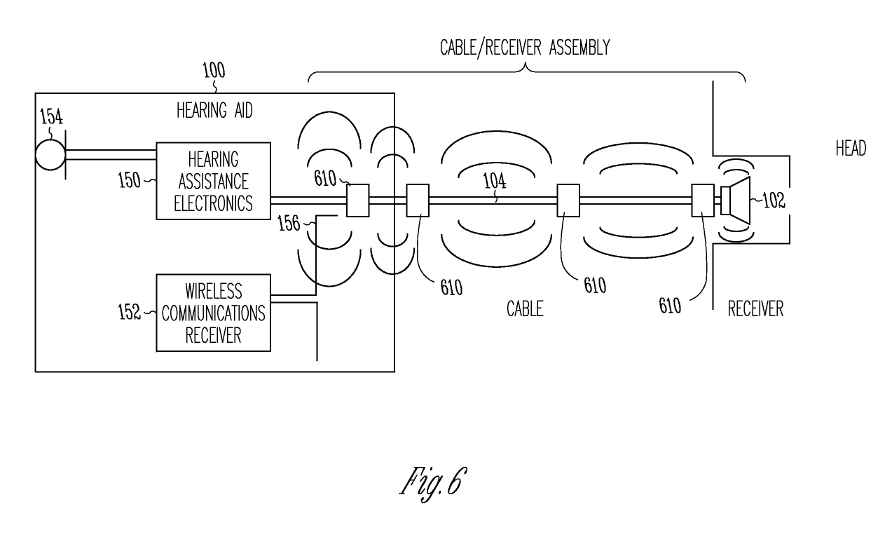

FIG. 5 illustrates a schematic diagram of a receiver-in-the-canal (RIC) hearing assistance device with an adjustably located circuit component, according to various embodiments of the present subject matter. The depicted embodiment includes a series circuit component 510 having a location that can be adjusted for desired electrical length (quarter wavelength, for example) and balance between radiation efficiency and sensitivity to head gap and tissue density variations for wearers. In various embodiments, inserting a relatively high impedance in a cable-receiver assembly in a location a small distance from the head/tissue to reduce current flow that would be in very close proximity to human tissue reduces the tissue loading effects. In various embodiments, adjusting the distance from head/tissue loading is used to maximize antenna system gain for the desired range of users. FIG. 6 illustrates a schematic diagram of a receiver-in-the-canal (RIC) hearing assistance device with multiple circuit components, according to various embodiments of the present subject matter. The depicted embodiment uses circuit components in multiple (distributed) locations to gradually reduce RF current flow.

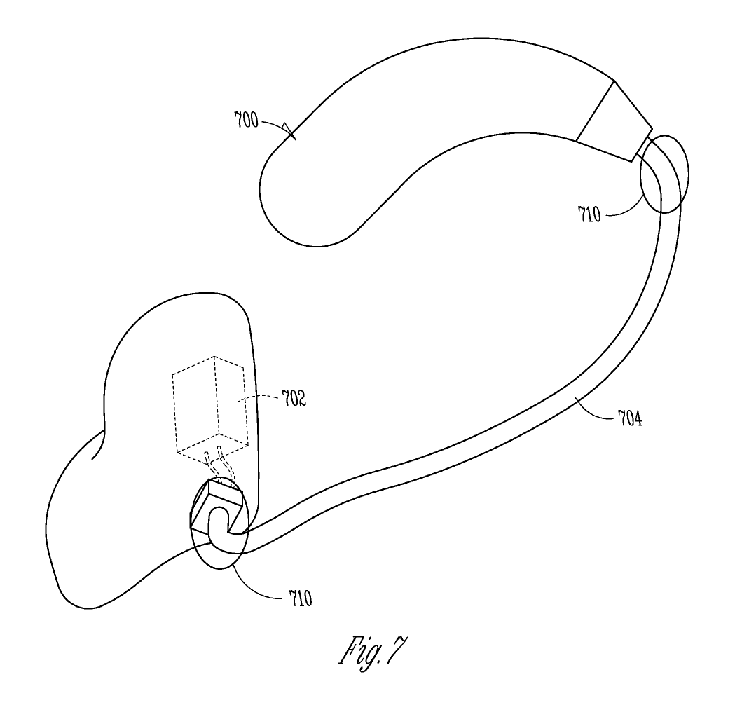

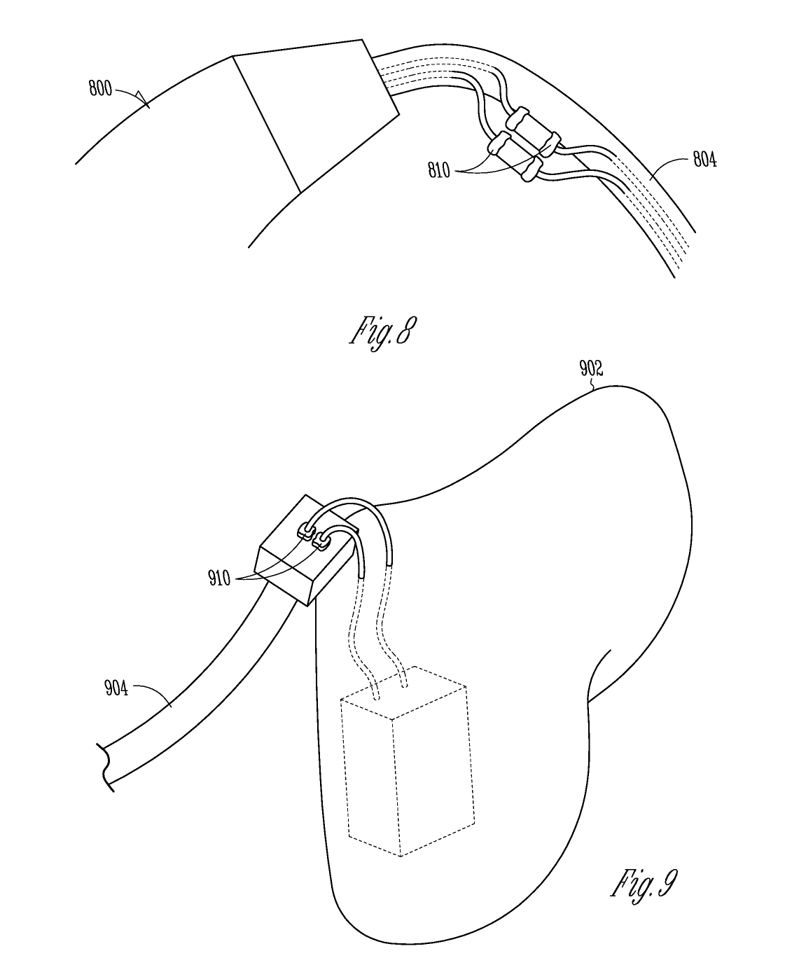

FIG. 7 illustrates a cross-sectional view of a receiver-in-the-canal (RIC) hearing assistance device, according to various embodiments of the present subject matter. The RIC device includes an antenna within a device housing 700, an audio receiver 702 configured to be worn in an ear canal of a wearer, and a cable assembly 704 configured to connect the audio receiver 702 to the device housing 700. A ferrite bead or an inductor 710 is connected to the cable assembly (as shown in FIGS. 8 and 9) and configured to reduce unwanted coupling between the cable assembly and the antenna by reducing high frequency current through the wires of the cable assembly. The antenna can have a variety of configurations, including an antenna having an aperture, in various embodiments.

FIG. 8 illustrates a portion of a receiver cable 804 for connecting to a device housing 800, according to various embodiments of the present subject matter. In various embodiments, ferrites (such as ferrite beads) or inductors 810 are connected in series in the receiver cable lines to reduce or control induced RF current flow on the receiver/cable assemblies to control gain and make antenna performance more consistent for a variety of wearers. In the depicted embodiment, the ferrites or inductors 810 are connected directly adjacent to the device housing 800, thus close to but outside of the aperture of the antenna.

FIG. 9 illustrates a portion of a receiver cable 904 for connecting to a receiver assembly 902, according to various embodiments of the present subject matter. In various embodiments, ferrites (such as ferrite beads) or inductors 910 are connected in series in the receiver cable lines to reduce or control induced RF current flow on the receiver/cable assemblies to control gain and make antenna performance more consistent for a variety of wearers. In the depicted embodiment, the ferrites or inductors 910 are connected directly adjacent to the receiver assembly 902.

In various embodiments, using a ferrite bead or inductor that has impedance higher than 550 ohms at 900 MHz reduces transmit and receive variance from 11 dB to less than 1 dB, a more than 10 dB improvement. In one embodiment, two ferrite beads are used to open the flow of current to the audio receiver wires. In various embodiments, the ferrite bead or inductor is located as close as possible to the silicon connector used to connect the cable assembly to the receiver or the device housing. In various embodiments, a ferrite bead or inductor is placed at each end of the cable assembly (as shown in FIG. 7).

In various embodiments, the present subject matter can be applied with one or more RIC cable assembly conductors. The present subject matter can be applied with one or more combinations of one or more RIC cable assembly component types—receivers, microphones, giant magneto-resistive device (GMR), telecoil, etc., in various embodiments.

According to various embodiments, other components such as capacitors (instead of or in addition to ferrites or inductors) could be used to control antenna gain. In further embodiments, combinations of components can be used. In still further embodiments, components such as ferrite beads or inductors are mounted on a printed circuit board (PCB), mounted in the hearing aid assembly housing but outside of the hearing aid antenna aperture, mounted in the cable, and/or mounted in the receiver assembly. In various embodiments, a component such as a ferrite bead or inductor is connected in series to other assemblies outside of the hearing aid antenna aperture to control current induced on cables and various hearing aid electronics or components (i.e. external microphones, an external giant magnetoresistive (GMR) sensor, a head sensor, etc.). In various embodiments, cable and/or receiver assemblies are manufactured to include the inductors or ferrites. The present subject matter improves performance management of the antenna system, in various embodiments.

Various embodiments of the present subject matter support wireless communications with a hearing assistance device. In various embodiments the wireless communications can include standard or nonstandard communications. Some examples of standard wireless communications include link protocols including, but not limited to, Bluetooth™, IEEE 802.11 (wireless LANs), 802.15 (WPANs), 802.16 (WiMAX), cellular protocols including, but not limited to CDMA and GSM, ZigBee, and ultra-wideband (UWB) technologies. Such protocols support radio frequency communications and some support infrared communications. Although the present system is demonstrated as a radio system, it is possible that other forms of wireless communications can be used such as ultrasonic, optical, infrared, and others. It is understood that the standards which can be used include past and present standards. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, SPI, PCM, ATM, Fibre-channel, Firewire or 1394, InfiniBand, or a native streaming interface. In various embodiments, such connections include all past and present link protocols. It is also contemplated that future versions of these protocols and new future standards may be employed without departing from the scope of the present subject matter.

It is understood that variations in communications protocols, antenna configurations, and combinations of components may be employed without departing from the scope of the present subject matter. Hearing assistance devices typically include an enclosure or housing, a microphone, hearing assistance device electronics including processing electronics, and a speaker or receiver. It is understood that in various embodiments the microphone is optional. It is understood that in various embodiments the receiver is optional. Antenna configurations may vary and may be included within an enclosure for the electronics or be external to an enclosure for the electronics. Thus, the examples set forth herein are intended to be demonstrative and not a limiting or exhaustive depiction of variations.

It is further understood that any hearing assistance device may be used without departing from the scope and the devices depicted in the figures are intended to demonstrate the subject matter, but not in a limited, exhaustive, or exclusive sense. It is also understood that the present subject matter can be used with a device designed for use in the right ear or the left ear or both ears of the wearer.

It is understood that the hearing aids referenced in this patent application include a processor. The processor may be a digital signal processor (DSP), microprocessor, microcontroller, other digital logic, or combinations thereof. The processing of signals referenced in this application can be performed using the processor. Processing may be done in the digital domain, the analog domain, or combinations thereof. Processing may be done using subband processing techniques. Processing may be done with frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, audio decoding, and certain types of filtering and processing. In various embodiments the processor is adapted to perform instructions stored in memory which may or may not be explicitly shown. Various types of memory may be used, including volatile and nonvolatile forms of memory. In various embodiments, instructions are performed by the processor to perform a number of signal processing tasks. In such embodiments, analog components are in communication with the processor to perform signal tasks, such as microphone reception, or receiver sound embodiments (i.e., in applications where such transducers are used). In various embodiments, different realizations of the block diagrams, circuits, and processes set forth herein may occur without departing from the scope of the present subject matter.

The present subject matter is demonstrated for hearing assistance devices, including hearing aids, including but not limited to, behind-the-ear (BTE), in-the-ear (ITE), in-the-canal (ITC), receiver-in-canal (RIC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard, open fitted or occlusive fitted. It is understood that other hearing assistance devices not expressly stated herein may be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A receiver-in-canal (RIC) hearing assistance device for a wearer, comprising:
a device housing;
an antenna within the device housing;
an audio receiver configured to be worn in an ear canal of a wearer;
a cable assembly configured to connect the audio receiver to the device housing; and
a circuit component connected to the cable assembly and configured to control coupling between the cable assembly and the antenna by enhancing high frequency current through wires of the cable assembly.

2. The device of claim 1, wherein the circuit component includes a ferrite bead.

3. The device of claim 1, wherein the circuit component includes an inductor.

4. The device of claim 1, wherein the circuit component includes a capacitor.

5. The device of claim 1, wherein the circuit component is connected in series with the cable assembly.

6. The device of claim 1, wherein the circuit component is connected to the cable assembly adjacent to the device housing.

7. The device of claim 1, wherein the circuit component is located adjacent the device housing outside of an antenna aperture.

8. The device of claim 1, wherein the circuit component is located in the cable assembly adjacent the audio receiver.

9. The device of claim 1, wherein the circuit component is adjustably located along the cable assembly.

10. The device of claim 9, wherein the circuit component is configured to be adjusted for a prescribed electrical length.

11. The device of claim 9, wherein the circuit component is configured to be adjusted for a prescribed radiation efficiency of the cable assembly.

12. The device of claim 9, wherein the circuit component is configured to be adjusted for a prescribed sensitivity to head gap variation.

13. The device of claim 1, comprising multiple circuit components connected in series to the cable assembly.

14. A method, comprising:
connecting a circuit component to a cable assembly configured to connect an audio receiver configured to be worn in an ear canal to a hearing assistance device housing, the circuit component configured to control coupling between the cable assembly and the antenna by enhancing high frequency current through wires of the cable assembly.

15. The method of claim 14, wherein connecting a circuit component to a cable assembly includes connecting a ferrite bead to the cable assembly.

16. The method of claim 14, wherein connecting a circuit component to a cable assembly includes connecting an inductor to the cable assembly.

17. The method of claim 14, wherein connecting a circuit component to a cable assembly includes connecting a capacitor to the cable assembly.

18. The method of claim 14, further comprising connecting multiple circuit components along the cable assembly.

19. The method of claim 14, wherein connecting the circuit component includes connecting the ferrite bead or the inductor in series to the cable assembly adjacent the housing.

20. The method of claim 14, wherein connecting the circuit component includes connecting the ferrite bead or the inductor adjacent a receiver assembly housing the audio receiver.
